(19) United States
(12) Patent Application Publication
(10) Pub. No.: US 2016/0145154 A1
(43) Pub. Date: May 26, 2016

(54) PROCESS FOR RECYCLING AQUEOUS SLUDGE AND/OR WASTE

(71) Applicant: WUJI YIN, Changsha City (CN)

(72) Inventor: WUJI YIN, Changsha City (CN)

(21) Appl. No.: 14/376,989

(22) PCT Filed: Jul. 25, 2013
(86) PCT No.: PCT/CN2013/088163

§ 371 Date: Aug. 6, 2014

(30) Foreign Application Priority Data
Jul. 25, 2013 (CN) 201310315939.2
Jul. 30, 2013 (CN) 201310323996.5

(51) Int. Cl. C04B 7/24; C10L 9/10; C02F 11/00

(52) U.S. Cl. CPC C04B 7/24; C02F 11/008; C10L 9/10; C10L 2290/24; C10L 2290/28

(57) ABSTRACT

The present disclosure relates to a process for recycling aqueous sludge and/or waste, comprising: adding, in a dry process cement production line, the aqueous sludge and/or waste into a raw material or into a vertical mill simultaneously with the raw material, and mixing and grinding the raw material and the aqueous sludge and/or waste in the vertical mill to prepare a raw material powder containing the aqueous sludge and/or waste, wherein the water content in the resulting mixture is adjusted to be within the range from 3% to 15% by weight, so that the comprehensive water content and material plasticity of the mixture in the vertical mill can be adjusted, and then calcining the obtained raw material powder containing the aqueous sludge and/or waste into cement clinker by a conventional means; or mixing and grinding coal briquettes and the aqueous sludge and/or waste to prepare pulverized coal containing the sludge and/or waste, so that the water content and plasticity of the coal can be adjusted and combustion performance of the coal can be improved, wherein the adding amount of the aqueous sludge and/or waste range(s) from 1% to 30% by weight of the coal briquettes. The present disclosure also provides a cement raw material powder and a pulverized coal prepared by said process.

### FIELD OF THE INVENTION

The present disclosure relates to a process for recycling aqueous sludge and/or waste, in particular to use of aqueous sludge and/or waste in improving working conditions of a vertical mill or combustion performance of pulverized coal.

### BACKGROUND OF THE INVENTION

In addition to clay minerals, aqueous sludge further comprises organics, pathogenic microorganisms, or toxic and hazardous substances. Due to a high water content and a flocculent water retention structure contained in aqueous sludge, harmless treatment thereof is extremely difficult, and direct implementation of resource utilization is more difficult.

Currently, besides landfilling, composting, potting, etc., advanced technologies for the treatment of aqueous sludge in the world can be divided into three categories. The first category makes use residual heat of thermal power or cement kiln exhaust gas to dry aqueous sludge in a special sludge drying equipment system, after which dried sludge can be served as an alternative fuel. For example, CN102173554A discloses a system for drying and disposing sludge by exhaust gas generated in cement production, which includes a novel dry-method cement clinker firing system, a wet sludge drying system, a dry sludge storage and cement kiln feeding system, and an electrical dragging and automatic control system. By adding a special drying device, sludge can be dried by using residual heat of a grate cooler of the cement kiln, followed by further treatment. However, it is actually difficult to dry aqueous sludge presenting a flocculent water retention structure, and the drying efficiency is low. The second category is to directly add aqueous sludge into a cement kiln, that is, to directly add aqueous sludge into a grate cooler, a kiln tail smoke chamber, a decomposing furnace, or a connecting pipe of kiln and furnace. The high water content in aqueous sludge severely affects normal operation of the kiln. The third category is a catalytic oxidation treatment of aqueous sludge under high temperature and high pressure, which requires large investments, and therefore has limited handling capacity.

CN1868939A discloses a method for directly treating sludge by using high-temperature clinker in cement production, wherein the sludge is directly added into a high-temperature clinker dumping area or a grate cooler during cement production via custody transfer. This method hardly enables homogeneous mixing of wet sludge and high-temperature clinker, and has disadvantages of poor heat exchange and low handling capacity. Large water content in wet sludge entering the kiln will severely affect normal operation of the kiln, and further affect quality of cement products.

CN101172790A discloses a new process for producing cement by using secondary batching of wet sludge and waste. In this process, wet industrial waste, municipal sewage sludge or water treatment sludge after pressure filtration, centrifugal dewatering, or draining off, is used as a raw material to perform a secondary dry and wet batching with other primarily batched and ground raw materials. After homogeneous mixing, rawmix rods or balls are produced, dried by residual heat, and added into a mechanical shaft kiln in a cement production line to be fired into clinker. This process uses wet sludge to produce cement via secondary batching. Thus the procedure is long, and it is not suitable for dry process cement production technology because of the use of a mechanical shaft kiln.

The effects of practical application for the above methods are poor. Furthermore, they require large investments and the procedures are complicated.

On the other hand, when a raw material vertical mill or a vertical coal mill in the dry process cement production line is working, materials to be ground generally need to contain 3-15 wt % of comprehensive water content and corresponding plasticity due to, structure characteristics and special working principles of the vertical mill. When the comprehensive water content of materials is lower than 3%, the formation of rolling material layers in the vertical mill is not efficient. As a result, the mill is easy to vibrate and therefore difficult to operate stably, thus losing its grinding advantages. Currently, non-plastic siliceous materials such as shale, sandstone, and silica are commonly used as raw materials. Most of these materials have a low water content. Among them the largest used limestone material usually has a water content lower than 1% and its comprehensive water content is lower than 3% in most cases. Hence, the vertical mill is equipped with a spray humidification system to properly perform humidification to materials therein. Thus the comprehensive water content of materials in the vertical mill can be increased and stable rolling material layers are formed. In this way, the grinding advantages of the vertical mill can be brought into full play. Moreover, the method of denitration of ammonium hydroxide and urea commonly used in the current dry process cement production line not only consumes heat and increases costs, but also competes with crops for fertilizer.

Furthermore, research indicates that sludge and waste contain abundant combustibles, and have high contents of elements of C, H, O, and N. Their ignition temperature is low and mostly is only 300-500° C. Also most of sludge and waste have a dry basis calorific value ranging from 2,800 Kcal/kg to 4,500 Kcal/kg, and a few have a dry basis calorific value up to 7,000 Kcal/kg. The matter of sludge and waste on a dry basis has better combustion performance than lignite, and therefore is a useful and renewable energy source that can improve combustion performance of anthracite and low quality coal. However, an efficient, low-cost and easy to operate method for using sludge and waste has not been developed yet. Neither investigation into nor use of sludge or waste in improving combustion performance of pulverized coal has been reported.

### SUMMARY OF THE INVENTION

In order to better recycle aqueous sludge and/or waste and solve the problems of insufficient utilization of aqueous sludge and/or waste, large investments, and complicated procedures in the prior art, the present disclosure provides a new process for recycling aqueous sludge and/or waste. Via the process of the present disclosure, aqueous sludge and/or waste can be used in the dry process cement production to adjust the comprehensive water content and material plasticity of materials in the raw material vertical mill or coal mill, and to adjust combustion performance of pulverized coal in the preparation and use of pulverized coal for heating and thermal power boilers.

The present disclosure provides a process for recycling aqueous sludge and/or waste, comprising:

adding, in a dry process cement production line, the aqueous sludge and/or waste into a raw material or into a vertical mill simultaneously with the raw material, and

mixing and grinding the raw material and the aqueous sludge and/or waste in the vertical mill to prepare a raw material powder containing the aqueous sludge and/or waste, wherein the water content in the resulting mixture is adjusted to be within the range from 3% to 15% by weight, so that the comprehensive water content and material plasticity of the mixture in the vertical mill can be adjusted, and then calcining the obtained raw material powder containing the aqueous sludge and/or waste into cement clinker by a conventional means; or

mixing and grinding coal briquettes and the aqueous sludge and/or waste to prepare pulverized coal containing the sludge and/or waste, so that the water content and plasticity of the coal can be adjusted and combustion performance of the coal can be improved, wherein the adding amount of the aqueous sludge and/or waste range(s) from 1% to 30% by weight of the coal briquettes.

In one preferred embodiment of the present disclosure, coal briquettes and said aqueous sludge and/or waste are simultaneously added into a vertical coal mill to adjust the water content and plasticity of the coal and to produce pulverized coal containing the aqueous sludge and/or waste. Alternately, in the preparation of pulverized coal used in boilers, aqueous sludge and/or waste are/is added into the coal mill to produce pulverized coal containing the aqueous sludge and/or waste, so as to improve combustion performance of the pulverized coal. The adding amount of said aqueous sludge and/or waste is 1-30 wt % of said coal briquettes. Preferably, in the preparation of pulverized coal for heating/thermal power boilers, said aqueous sludge and/or waste are/is added to coal briquettes and ground together to produce pulverized coal containing sludge and/or waste.

The present disclosure provides specific and preferable embodiments for effectively using different sludge or waste based on the features of sludge or waste, conditions of the vertical mill, and heat supply in the dry process cement production line in different regions or conditions of the coal mill in the thermal power production line in different regions, so as to sufficiently use different aqueous sludge and/waste.

In one preferred embodiment of the present disclosure, the water content in said aqueous sludge and/or waste is less than or equal to 99%, preferably less than or equal to 90%.

In a further preferred embodiment of the present disclosure, said aqueous sludge and/or waste are/is selected from the group consisting of municipal water treatment sludge, agricultural processing waste, petrochemical sludge, organic sludge from a printing and dyeing factory, kitchen waste, industrial waste oils, and deposited sludge in rivers, lakes, or ponds.

In a further preferred embodiment of the present disclosure, the adding amount of aqueous sludge and/or waste is 2-20% by weight of materials in the raw material vertical mill. The adding amount of aqueous sludge and/or waste is determined based on the features of raw materials in a specific dry process cement production line and physical properties of aqueous sludge and/or waste, such as the hardness and water content of limestone, the water content and plasticity index of sandstone, shale or clay and so on, as well as the variety and characteristics of aqueous sludge and/or waste, to meet the requirements of the comprehensive water content and plasticity of materials in the raw material vertical mill.

In the process of the present disclosure, aqueous sludge and/or waste are/is added into raw materials or the vertical mill in the area between the material shed or silo and the raw material vertical mill according to physical properties of aqueous sludge and/or waste such as the water or solid content, mobility, or plastic viscosity. Aqueous sludge and/or waste are/is added via a conventional means using a general equipment or device. In the present disclosure, when the water content in aqueous sludge and/or waste is less than or equal to 95%, or the effect of the contents of inorganic components are beyond the error range allowable in batching, the contents of chemical constituents of inorganic components, i.e., SiO₂, Al₂O₃, Fe₂O₃, CaO, MgO, K₂O, Na₂O, P₂O₅ are brought into the ingredients calculation of raw materials. When the water content of aqueous sludge and/or waste is higher than or equal to 95%, or when the contents of inorganic components are within the error range allowable in batching, the inorganic components can be neglected.

In one preferred embodiment of the present disclosure, the adding amount of said aqueous sludge and/or waste are/is 5-20 wt % of coal briquettes.

In one preferred embodiment of the present disclosure, said pulverized coal has a residue less than or equal to 18% on sieve of 80 μm.

In one preferred embodiment of the present disclosure, the aqueous sludge and/or waste added into the coal briquettes have/has a water content less than or equal to 99 wt %, and a dry basis organic content higher than or equal to 40 wt %, preferably selected from the group consisting of municipal water treatment sludge, petrochemical sludge, organic sludge from a printing and dyeing factory, kitchen waste, industrial waste oils, and pharmaceutical processing waste, such as cassava residues, residues and waste liquids from a sugar refinery, oil extraction residues, dregs of a decoction, melon and grain husks, plant slag, biogas rot slag, and livestock manure and so on.

Moreover, the aqueous sludge and/or waste added into the granular coal have/has a water content less than or equal to 99% by weight, and a dry basis organic content higher than or equal to 40% by weight.

Furthermore, said aqueous sludge and/or waste are/is added in the areas between the material shed and an inlet of the coal mill, which means that aqueous sludge and/or waste are/is added to the granular coal or dispersible granular coal in predetermined proportions in one or a plurality of places between the coal shed and the inlet of the coal mill by using a commonly used equipment or device (such as a metering/feeding device, a forklift, a material taking and distributing machine, a distributing device, a mud pump, and a pump truck) in a conventional means. Alternately, a sludge pump can be used to directly spray the aqueous sludge and/or waste or smashed slurry waste into a coal mill with a grinding mechanism, a hammer mechanism, or a fan grinding mechanism.

In addition, said coal mill is a coal mill that supplies heat by hot air for grinding pulverized coal, such as a vertical coal mill or an air swept mill used in a cement enterprise for grinding of pulverized coal, a steel ball roller coal mill used in a thermal power enterprise for grinding of pulverized coal, a ball, bowl, flat disc, or roller medium-speed coal mill, a hammer, shaft, or fan high-speed coal mill.

The present disclosure further provides a cement raw material powder prepared by said process, wherein its raw material contains 2-20% by weight of said aqueous sludge and/or waste.

The present disclosure still further provides a pulverized coal prepared by said process, wherein its raw material contains 1-30% by weight of said aqueous sludge and/or waste.

The technical principles of the present disclosure may read as follows, which are not to limit the present disclosure in any manner.

1. The present disclosure aims specifically at solving the biggest problem in the treatment or use of high-water sludge which has strong water retention capacity and plastic viscosity. It has been extremely difficult to dehydrate and dry high-water sludge because of its flocculent structure. As a matter of fact, the water contained in aqueous sludge and plastic viscosity thereof can precisely offer a proper amount of water and relative plasticity required by materials in the raw material vertical mill or vertical coal mill in the dry process cement production line, thereby enabling the formation of good grinding material layers in the vertical mill and achieving resource utilization of the aqueous sludge. On the other hand, the flocculent water retention structure in aqueous sludge can be destroyed to release free water under extrusion and friction caused by powerful grinding of the sludge and non-plastic limestone or sandstone in the raw material vertical mill, or by powerful grinding of the sludge and non-plastic particles of anthracite and low quality coal in the vertical coal mill. As a result, the sludge becomes easy to dry under the waste hot airflow in the vertical mill, and a sterile raw material powder or pulverized coal containing the sludge can be prepared.

2. The raw material powder produced by the dry process cement production contains homogeneously distributed organic particles and a variety of inorganic particles. Since merely the sum content of the inorganic chemical particles requires further consideration, the organic components in the raw material powder originally contained in the sludge can be decomposed and combusted in the pre-heater or the decomposing furnace, and the heat generated therein can be put into use. Meanwhile, organic components rich in ammonia and nitrogen compounds and hydrocarbons contained in the sludge in the raw material, as denitrifying agents, can simultaneously perform excellent denitration. The inorganic components contained in the sludge, as an ingredient of the raw material, finally enter the rotary kiln with the raw material and are converted to an ingredient of clinker, wherein harmful heavy metal elements are fixedly melted in the clinker mineral. The exhaust gas generated in complete burning of the organic components can be effectively handled in the pre-heater and a dust removal system in the dry process cement production system.

3. Industrial coal is a brittle material and contains complex polymers having adsorption effect, which is similar with the organic components contained in sludge or waste. Therefore, after repeated and violent spreading, impacting, or grinding, homogeneous particles of industrial coal and the sludge and waste can be formed, and low-molecular substances such as those with peculiar odor can be adsorbed.

4. The flocculent water retention structure in the sludge or waste can be completely destroyed to release free water under the function of granulated coal generated from violent and repeated extrusion and friction in the coal mill. As a result, the sludge or waste dispersed in the granulated coal is easy to dry under high-temperature airflow in the coal mill, and the effect of sterilization is achieved. The sludge or waste added to the vertical coal mill can also adjust the comprehensive water content and plasticity of coal materials in the vertical coal mill, whereby industrial water can be saved.

5. The organic components in the sludge or waste that have been combined with coal particles and homogeneously distributed in the coal particles have good flammability and low ignition temperatures. Therefore they can reduce the ignition temperature of the pulverized coal and offer heat for the carbon heating in the coal, so as to improve the flammability and burn-off rate of the pulverized coal. Meanwhile, the substances with peculiar odor can also be burned out and the heavy metals contained in the sludge or waste are fixedly melted into the ash generated from the combustion of the pulverized coal.

6. Brittle coal used in an industrial kiln has the characteristics of non-plasticity and adsorption. And the coal mill generally adapts to the coal material containing a water content in the range from 4% to 15%, or at most in the range from 15% to 25%. Taking advantage of these characteristics, the amount of cold airflow blown into the mill can be controlled and/or the amount of hot airflow of the residual heat blown into the mill can be appropriately increased, so that the water contained in the organic components of aqueous sludge and/or waste can be prevented from negatively influencing the production capacity of the coal mill.

### DETAILED DESCRIPTION OF THE EMBODIMENTS

The embodiments of the present disclosure will be further explained in connection with specific examples, whereby the procedures can be fully understood and therefore implemented as to how the present disclosure solves the technical problems by using the technical means and achieves the technical effects. It should be noted that, as long as there are no conflicts, the technical features disclosed in each and every example of the present disclosure can be combined with one another in any way, and all technical solutions formed are within the scope of the present disclosure.

### Example 1

In a Φ3.0×47 m dry process cement production line, the processes of raw materials homogenization with a forklift in the shed, grab and conveyance of raw materials with a forklift, formulation in a silo, and grinding in a vertical mill were accomplished in the raw material section. The raw material was formulated by limestone, clay, sandstone, and sulfuric acid residues, and the output of the raw material vertical mill was 90 t/h. Water was sprayed into the vertical mill at a rate of 6 t/h. 17% aqueous ammonia was used for denitration in a decomposing furnace of the cement kiln system, with a consumption of approximately 200 kg/h. The amount of NOₓ tested online ranged from 380 mg/Nm³ to 450 mg/Nm³.

In the present example, the raw material was formulated as described above except that 20 wt % of aged sludge was added to replace clay. Said sludge was taken from aged sludge stored in the open-air in a sewage treatment plant and its average water content was 37.3 wt %. The sludge and raw material were first mixed with a forklift in the shed, and then, after material batching, continuously fed into a raw material vertical mill to be ground, (wherein no water was sprayed). When the air blown into the mill was increased by 0.5%, the output of the vertical mill became stable at 90 t/h, and the fineness of the raw material from the outlet of the mill was decreased from 17% to 14%. After the raw material powder containing sludge was fed into the kiln, no aqueous ammonia was sprayed into the decomposing furnace and the amount of NOₓ tested online was still stable at about 400 mg/Nm³. The air blown into the kiln system and the output of the system kept unchanged. The kiln remained in normal conditions. The consumption of coal decreased by 2%, and the quality of the clinker was tested to be normal. That is, 20% of aged sludge with a water content of 37.3% solved the problem of spray humidification in the raw material vertical mill, and had no negative influence on the conditions of the kiln, or on output and quality of the product, while the cost for denitration was reduced and the coal and clay were saved.

### Example 2

In a Φ3.5×52 m dry process cement production line, the raw material was formulated by limestone, shale, phosphorus slag, and steel slag, wherein the limestone was homogenized in the limestone shed by a forklift with broken stones of two grades, and the phosphorus slag and steel slag were homogeneously mixed with a forklift in the shed. The output of the raw material vertical mill was 120 t/h. Water was sprayed into the vertical mill at a rate of about 9 t/h in a dry climate. 17.5% aqueous ammonia was used for denitration in a decomposing furnace of the cement kiln system, with a consumption of approximately 220 kg/h. The amount of NOₓ tested online was about 400 mg/Nm³.

In the present example, 6 wt % of sludge was further added to the above mixed ingredients, wherein said sludge, with an average water content of 85.3 wt %, was taken from biochemical sludge from a treatment plant. Said sludge in a sludge tank was directly scattered on the broken stones. The broken stones and sludge were first mixed by the forklift and then, after material batching with shale, phosphorus slag, and steel slag, were fed into a raw material vertical mill to be ground, (wherein no water was sprayed). The output of the vertical mill per hour and the fineness of the raw material kept substantially unchanged. Under the condition that the process parameters of the kiln system were not adjusted, the raw material powder containing sludge was fed into the kiln system via a conventional means. The dosage of aqueous ammonia in the decomposing furnace was reduced by 50%. The conditions of the kiln and the output and quality of the product kept unchanged, while the dosage of tail coal was reduced by 2%, and the amount of NOₓ tested online was stable at below 400 mg/Nm³. That is, 6 wt % of biochemical sludge with a water content of 85.3% solved the problem of spray humidification in the raw material vertical mill, and had no negative influence on the kiln system, while the material cost for denitration was reduced by 50% and the dosage of coal was decreased.

### Example 3

In a Φ4.3×64 m dry process cement production line, the raw material was formulated by limestone, sandstone, coal ash, and sulfuric acid residues. The output of the raw material vertical mill was 250 t/h. Water was sprayed into the vertical mill at a rate of about 9-17 t/h by an automatic adjustment system. 17.5% aqueous ammonia was used for denitration in a decomposing furnace of the cement kiln system, with a consumption of approximately 330 kg/h. The amount of NOₓ tested online was 380-450 mg/Nm³.

In the present example, 13 wt % of sludge was further added to the above mixed ingredients, wherein said sludge, with an average water content of 86.7 wt %, was taken from digested sludge from a sewage treatment plant. Said sludge in a tank was conveyed with a sludge pump, and homogeneously scattered on the limestone layer placed on the conveyor belt of the raw material batching system. The sludge and limestone were batched with the sandstone, coal ash, and sulfuric acid residues, then the mixed ingredients were fed into a raw material vertical mill to be ground, (wherein no water was sprayed). The output of the vertical mill per hour stayed constant, while the fineness of the raw material decreased by 1.5%. Under the condition that the process parameters of the kiln system were not adjusted, the raw material powder containing sludge was fed into the kiln system via a conventional means. The dosage of aqueous ammonia in the decomposing furnace was reduced to one third. The conditions of the kiln and the output and quality of the product kept unchanged, and the amount of NOₓ tested online was stable at below 400 mg/Nm³. That is, 13 wt % of digested sludge with a water content of 86.7% solved the problem of spray humidification in the raw material vertical mill, and had no negative influence on the kiln system, while the material cost for denitration was reduced by two thirds.

### Example 4

In a Φ4×60 m dry process cement production line, the raw material was batched by four components consisting of limestone, shale, phosphorus slag, and steel slag. The output of the raw material vertical mill was 210 t/h. Water was sprayed into the vertical mill at a rate ranging from 5 t/h to 13 t/h. 17.5% aqueous ammonia was used for denitration in a decomposing furnace of the cement kiln system, with a consumption of approximately 290 kg/h. The amount of NOₓ tested online was 380-480 mg/Nm³.

In the present example, 8 wt % of sludge was further added to the above mixed ingredients, wherein said sludge, with an average water content of 78.2 wt %, was taken from cassava processing waste. Said waste in a sludge tank was transported to a feeding mouth of the raw material vertical mill and an air-lock feeding sub-grid wheel below the feeding mouth by two shunting sludge pump lines. The waste from the above two inlet positions was homogeneously scattered in the ingredients of the raw material, and fed into the vertical mill with the mixed ingredients to be ground, (wherein no water was sprayed). The air blown into the vertical mill was increased by 1%. The output of the vertical mill per hour and the fineness of the raw material kept substantially unchanged. Under the condition that the process parameters of the kiln system were not adjusted, the raw material powder containing cassava waste was fed into the kiln system via a conventional means. The dosage of aqueous ammonia in the decomposing furnace was reduced to one third. The conditions of the kiln and the output and quality of the product kept unchanged, and the amount of NOₓ tested online was stable at below 400 mg/Nm³. That is, 8 wt % of cassava processing waste with a water content of 78.2% solved the problem of spray humidification in the raw material vertical mill, and had no negative influence on the kiln system, while the material cost for denitration was reduced by two thirds.

### Example 5

In a Φ4.8×74 m dry process cement production line, the raw material was formulated with four components consisting of limestone, shale, phosphorus slag, and sulfuric acid slag. Two raw material vertical mills, model 3840, were used, each with an output of 220 t/h. Water was sprayed into each vertical mill at a rate ranging from 5 t/h to 13 t/h. 17.5% aqueous ammonia was used for denitration in a decomposing furnace of the cement kiln system, with a consumption of approximately 390 kg/h. The amount of NOₓ tested online was 300-500 mg/Nm³.

In the present example, 10 wt % of sludge was added to the above mixed ingredients, wherein said sludge, with an average water content of 73.7 wt %, was taken from sludge deposited in a city river. The water spraying system in the vertical mill was modified, that is, the orifice of the water spray pipe was enlarged. Said sludge in a sludge tank was conveyed into the original water inlet pipe of the raw material vertical mill by a sludge pump and sprayed into the vertical mill using the modified water spaying system. The air blown into the vertical mill was increased by 1%. The output of the vertical mill per hour and the fineness of the raw material kept substantially unchanged. Under the condition that the process parameters of the kiln system were not adjusted, the raw material powder containing sludge was fed into the kiln system via a conventional means. The dosage of aqueous ammonia in the decomposing furnace was reduced to 30%. The conditions of the kiln and the output and quality of the product kept unchanged, and the amount of NOₓ tested online was stable at below 400 mg/Nm³. That is, 10 wt % of the sludge deposited in a city river with a water content of 73.7% solved the problem of spray humidification in the raw material vertical mill, and had no negative influence on the kiln system, while the material cost for denitration was reduced by 70%.

### Example 6

The ignition and combustion condition of the airflow in the rotary kiln was simulated in a test room, wherein pulverized coal was sprayed into an electric furnace in a suspension state. The ignition temperatures of different types of pulverized coals tested are as follows.

| | Ignition |
|---|---|
| Type of coal | temperature |
| Lignite (volatile component: 49.1%) | 560° C. |
| Bituminous coal (volatile component: 39.4%) | 650° C. |
| Bituminous coal (volatile component: 30.2%) | 750° C. |
| Bituminous coal (volatile component: 20.6%) | 830° C. |
| Semibituminous coal (volatile component: 15.1%) | 890° C. |
| Anthracite (volatile component: 4.5%) | 970° C. |
| Dry sludge powder from a sewage treatment plant (content | 510° C. |
| of organics on a dry basis: 73.9%) | |
| Anthracite (volatile component: 4.5%) blended with 30 | 810° C. |
| wt % of sewage treatment sludge dewatered by pressure | |
| filtration (water content: 56%) | |
| Anthracite (volatile component: 4.5%) blended with 7 wt % | 860° C. |
| of organic sludge from a printing and dyeing factory (water | |
| content: 67%) | |
| Anthracite (volatile component: 4.5%) blended with 1.0 | 890° C. |
| wt % of waste oil | |
| Anthracite (volatile component: 4.5%) blended with 6 wt % | 870° C. |
| of tea oil extraction residues | |
| Anthracite (volatile component: 4.5%) blended with 6 wt % | 890° C. |
| of wet cow dung | |

Test results show that pulverized coal prepared by sludge and waste blended into anthracite presents significantly improved combustion performance and relatively ideal effects.

### Example 7

In a 2,500 t/d dry process cement production plant, the coal mill was a vertical mill and bituminous coal was used previously. The output of the vertical coal mill was 45 t/h and the pulverized coal was controlled as having a 2-3% residue on sieve of 80 urn. The coal was anthracite with an average volatile component of 6.9% and an average calorific value of 5,600 Kcal/Kg. Water was sprayed to the coal on the belt leading to the vertical coal mill. When the output of the coal mill was 40 t/h and the powder had a 3% residue on sieve of 80 μm, the vertical mill was substantially stable with just slight vibration. When the output of the coal mill was reduced to 36 t/h and the powder had a residue of less than 2% on sieve of 80 μm, the vibration amplitude of the vertical coal mill was reduced to less than 0.8 mm, which is a rather secured condition. The pulverized coal added into the kiln had an average calorific value of 5,560 Kcal/Kg. After the anthracite was burned in a special burner, the kiln had a relatively low flame temperature and produced a large amount of fly sand, severe crust in the rear kiln smoke chamber, crust rings in the rear of the kiln, material pouring in the rear of the kiln, and clinker-wrapped raw materials. 820 Kcal heat was consumed for every kilogram of clinker produced.

The present example employed sludge from a municipal sewage treatment plant. A sample of the sludge was tested to have an average water content of 85.6%, a dry basis organic content of 75%, and a dry basis calorific value of 3,207 Kcal/kg. Said sludge was transported to the cement production plant and pumped into a sludge tank. Water is no longer sprayed on the feeding belt. Said sludge at an amount accounting for 12 wt % of the granular anthracite was shunted by sludge pump lines into the vertical mill, half from the feeding belt and the other half from below a sub-grid wheel of a feeding mouth of the vertical mill. The obtained pulverized coal containing sludge had a residue of less than 2% on sieve of 80 μm. The output of the coal mill gradually became stable at 45 t/h, and the pulverized coal containing sludge added into the kiln had an average calorific value of 5,530 Kcal/Kg. When the pulverized coal containing the sludge was used, the kiln was bright at the head and had small amount of fly sand therein. Very little crust formed in the smoke chamber, and the crust rings previously formed in the kiln were gradually off. Clinker-wrapped raw materials substantially disappeared. The heat consumed for every kilogram of clinker produced was reduced to 781 Kcal. It is thus indicated that addition of 12 wt % of sludge with a water content of 85.6% can significantly improve the combustion performance of the pulverized coal and improve the burn-off rate thereof, whereby raw coal can be saved by 5%.

### Example 8

In a 1,500 t/d dry process cement production plant, the coal mill was an air swept mill and the coal was previously formulated with anthracite and bituminous at a ratio of 2:1 by weight. A forklift was used to measure, formulate, and mix the coal piles. The output of the air swept mill was 16 t/h, and the pulverized coal had a 1-3% residue on sieve of 80 μm. The pulverized coal added to the kiln had an average volatile component of 14.5% and an average calorific value of 5,100 Kcal/Kg. The kiln had a relatively low-temperature flame, a large amount of fly sand, severe crust in the rear smoke chamber, formation of crust rings in the rear of the kiln, frequent material pouring in the rear of the kiln, and appearance of clinker-wrapped raw materials. The heat consumption for every kilogram of clinker produced was calculated as 830 Kcal.

The present example employed aged sludge stockpiled in the open-air of a municipal sewage treatment plant. A sample of the sludge was tested to have an average water content of 43.7%, a dry basis organic content of 67.3%, and a dry basis calorific value of 3,215 Kcal/kg. The sludge was transported to the coal shed of the cement production plant, and a forklift was used to measure, formulate, and homogeneously mix the coal and sludge. The sludge formulated accounted for 10% by weight of the granular coal. The coal containing sludge, after being homogenized, was continuously fed into the air swept mill to be ground. The obtained pulverized coal containing sludge had a 2% residue on sieve of 80 μm. The output of the coal mill kept stable at 16 t/h, and the pulverized coal added to the kiln had an average calorific value of 5,095 Kcal/Kg. When the pulverized coal containing sludge was used, the amount of fly sand in the kiln is significantly reduced and crust formed in the smoke chamber became smaller. The crust rings in the kiln were gradually off and the problem of material pouring in the rear of the kiln was solved. Clinker-wrapped raw materials substantially disappeared. The heat consumption for every kilogram of clinker produced was reduced to 792 Kcal, saving 6% of coal. It is thus shown that addition of 10 wt % of the aged sludge can significantly improve the combustion performance of the pulverized coal and improve the burn-off rate thereof, whereby raw coal can be significantly saved.

### Example 9

In a 60,000 Kw thermal power workshop employing a steel ball roller coal mill, blended coal was previously used. The output of per coal mill was 48 t/h, and the pulverized coal had a 12% residue on sieve of R90. The pulverized coal added to the kiln had an average volatile component of 7.9%, and an average calorific value of 4,450 Kcal/Kg. Due to the low quality of coal, flameout tended to occur in the kiln, such that frequent spray of diesel was required to support the combustion. The loss on ignition of the slag ranged from 6% to 15%, (wherein the loss on ignition approximates the content of coke). The loss on ignition of the pulverized coal ranged from 9% to 17%. About 0.47 Kg of coal was used for every degree of electricity produced.

The present example employed digested sludge in a municipal sewage treatment plant. A sample of the sludge was tested to have an average water content of 83.6%, a dry basis organic content of 72%, and a dry basis calorific value of 3,307 Kcal/kg. Said sludge was transported to the thermal power workshop, pumped into a sludge tank, and continuously sprayed into the mill by a sludge pump from a coal drop inlet of a feeding machine arranged in the coal mill, wherein the sludge sprayed into the coal mill accounted for 13% by weight of the granular coal. The flow of hot air blown into the mill was increased by 2%. The pulverized coal containing sludge after being ground was controlled as having a 12% residue on sieve of R90. The output of the coal mill kept stable at 48 t/h, and the pulverized coal added to the kiln had an average calorific value of 4,450 Kcal/Kg. When the pulverized coal containing the sludge was used, no diesel was sprayed to support the combustion. The flame in the kiln was stable. The loss on ignition of furnace slag was reduced to 3-6% and the loss on ignition of pulverized coal ash was reduced to 3-5%. For every degree of electricity produced, the coal used was reduced to 0.43 Kg. It is thus shown that addition of the sludge accounting for 13 wt % of the coal can significantly improve the combustion performance of the pulverized coal and improve the burn-off rate thereof, whereby raw coal saved in producing per degree of electricity reaches 10.8%.

### Example 10

In a thermal power workshop employing an imported shallow bowl ball coal mill 923, blended coal was previously used. The output of per coal mill was 60 t/h and the pulverized coal had a 10% residue on sieve of R90. The pulverized coal added to the kiln had an average volatile component of 8% and an average calorific value of 4,350 Kcal/Kg. Due to the low quality of coal, flameout tended to occur in the kiln, such that frequent spray of diesel was required to support the combustion. The loss on ignition of the slag ranged from 5% to 7%, and the loss on ignition of the pulverized coal ranged from 3% to 9%. About 0.45 Kg of coal was used for every degree of electricity produced.

The present example employed digested sludge in a municipal sewage treatment plant. A sample of the sludge was tested to have an average water content of 84.6%, a dry basis organic content of 76%, and a dry basis calorific value of 3,110 Kcal/kg. The aqueous sludge was transported to the thermal power workshop, pumped into a sludge tank, and continuously sprayed into the coal mill by a sludge pump along the direction of coal drop from a coal drop pipe arranged in the central part of the mill, wherein the sludge sprayed into the coal mill accounted for 10% by weight of the granular coal. The flow of hot air blown into the mill was increased by 2%. The pulverized coal containing the sludge after being ground was controlled as having a 10% residue on sieve of R90. The output of the coal mill kept stable at 60 t/h, and the pulverized coal added to the kiln had an average calorific value of 4,350 Kcal/Kg. When the pulverized coal containing the sludge was used, no diesel was sprayed to support the combustion. The flame in the kiln was stable. The loss on ignition of furnace slag was reduced to 2-5% and the loss on ignition of pulverized coal ash was reduced to 1-3%. For every degree of electricity produced, the coal used was reduced to 0.43 Kg. It is thus shown that addition of the sludge accounting for 10 wt % of the coal can significantly improve the combustion performance of the pulverized coal and improve the burn-off rate thereof, whereby raw coal saved in producing per degree of electricity reaches 4.4%.

### Example 11

In a thermal power workshop employing an S-shaped fan coal mill, blended coal was previously used. The pulverized coal had a residue of 15% on sieve of R90. The pulverized coal added to the kiln had an average volatile component of 17%, and an average calorific value of 4,150 Kcal/Kg. Due to the low quality of coal, flameout tended to occur in the kiln, such that frequent spray of diesel was required to support the combustion. The loss on ignition of the slag ranged from 7% to 10%, and the loss on ignition of the pulverized coal ash ranged from 7% to 12%. About 0.45 Kg of coal was used for every degree of electricity produced.

The present example employed organic waste in a vegetable market. A sample of the waste was broken and tested to have an average water content of 57.6%, and a dry basis calorific value of 4,586 Kcal/kg. The organic waste in the vegetable market was transported to the coal shed of the thermal power workshop, homogenized by a forklift, and added into the coal to obtain a mixed coal, wherein the waste accounted for 15% by weight of the granular coal. The mixed coal was continuously fed into the fan mill via a feeding machine. The amount of hot air blown into the mill was increased by 3%. The fineness of the pulverized coal containing the sludge after being ground, and the output of the coal mill were unchanged. The pulverized coal added to the kiln had an average calorific value of 4,180 Kcal/Kg. When the pulverized coal containing the waste was used, no diesel was sprayed to support the combustion. The flame in the kiln was stable. The loss on ignition of furnace slag was reduced to 1-3%, and the loss on ignition of pulverized coal ash was reduced to 1-2%. For every degree of electricity produced, the coal used was reduced to 0.42 Kg. It is thus shown that addition of the waste accounting for 15 wt % of the coal can significantly improve the combustion performance of the pulverized coal and improve the burn-off rate thereof, whereby raw coal saved in producing per degree of electricity reaches 6.7%.

1. A process for recycling aqueous sludge and/or waste, comprising:
adding, in a dry process cement production line, the aqueous sludge and/or waste into a raw material or into a vertical mill simultaneously with the raw material, and
mixing and grinding the raw material and the aqueous sludge and/or waste in the vertical mill to prepare a raw material powder containing the aqueous sludge and/or waste, wherein the water content in the resulting mixture is adjusted to be within the range from 3% to 15% by weight, so that the comprehensive water content and material plasticity of the mixture in the vertical mill can be adjusted, and then calcining the obtained raw material powder containing the aqueous sludge and/or waste into cement clinker by a conventional means; or
mixing and grinding coal briquettes and the aqueous sludge and/or waste to prepare pulverized coal containing the sludge and/or waste, so that the water content and plasticity of the coal can be adjusted and combustion performance of the coal can be improved, wherein the adding amount of the aqueous sludge and/or waste range(s) from 1% to 30% by weight of the coal briquettes.

2. The process of claim 1, wherein the adding amount of said aqueous sludge and/or waste is 2-20% by weight of materials in the raw material vertical mill.

3. The process of claim 1, wherein the water content in said aqueous sludge and/or waste is less than or equal to 99%, preferably less than or equal to 90%.

4. The process of claim 1, wherein said aqueous sludge and/or waste is selected from the group consisting of municipal water treatment sludge, agricultural processing waste, petrochemical sludge, organic sludge from a printing and dyeing factory, kitchen waste, industrial waste oils, and deposited sludge in rivers, lakes, or ponds.

5. The process of claim 4, wherein the agricultural processing waste comprises at least one selected from the group consisting of cassava residues, residues and waste liquids from a sugar refinery, oil extraction residues, dregs of a decoction, melon and grain husks, plant slag, biogas rot slag, and livestock manure.

6. The process of claim 1, wherein the aqueous sludge and/or waste added to the coal briquettes is selected from those in which the content of organics is more than or equal to 40% by weight on a dry basis.

7. The process of claim 1, wherein said grinding is performed by using a coal mill.

8. The process of claim 7, wherein said coal mill is selected from the group consisting of a coal vertical mill, an air swept mill, a steel ball roller coal mill, a ball coal mill, a bowl coal mill, a flat disc coal mill, a roller coal mill, a hammer coal mill, a shaft coal mill, and a fan coal mill.

9. A cement raw material powder prepared by the process of claim 1, wherein its raw material contains 2-20 wt % of said aqueous sludge and/or waste.

10. A pulverized coal prepared by the process of claim 1, wherein its raw material contains 1-30% by weight of said aqueous sludge and/or waste.
